(19) United States
(12) Patent Application Publication
(10) Pub. No.: US 2026/0302656 A1
(43) Pub. Date: Oct. 1, 2026

(54) PROTECTIVE CONFIGURATION FOR ELECTRICAL OUTLET TERMINALS

(71) Applicant: Zhejiang Yuchuang Electronic Technology Co., Ltd., Wenzhou (CN)

(72) Inventors: Yangen CHEN, Wenzhou (CN); Jingzheng CHEN, Wenzhou (CN)

(21) Appl. No.: 19/415,404

(22) Filed: Dec. 10, 2025

(30) Foreign Application Priority Data
Mar. 28, 2025 (CN) 202520560953.7

(51) Int. Cl. H01R 4/70

(52) U.S. Cl. CPC H01R 4/70

(57) ABSTRACT

A protective configuration for electrical outlet terminals includes a main housing provided with terminals, where the main housing is provided with mounting grooves recessed inward from an outer surface of the main housing, and the terminals are mounted within the mounting grooves; and a flippable protective cover plate is disposed for each of the mounting grooves, an upper portion of the protective cover plate is pivotally connected to the main housing, a mutually engageable force-releasable snap-fit mechanism is disposed for the protective cover plate and the main housing, and the snap-fit mechanism is engaged when the protective cover plate is closed to cover the mounting groove. The flippable protective cover plates provide effective coverage for the terminals, and the force-releasable snap-fit mechanisms are configured to maintain the flippable protective cover plates in a covered state; and the protective cover plates are easy to open, thus achieving convenience for wiring operation.

### CROSS-REFERENCE TO RELATED APPLICATIONS

The present application claims priority to Chinese Patent Application No. 202520560953.7, filed Mar. 28, 2025, the entire disclosure of which is incorporated herein by reference.

### TECHNICAL FIELD

The present disclosure relates to electrical outlet products, and in particular to a protective configuration for electrical outlet terminals.

### BACKGROUND

A wall-mounted electrical outlet typically has rear-end terminals embedded into a wall structure. A faceplate covers peripheral gaps around a wall opening, and consequently no protective cover is designed for the terminals at the rear end of the electrical outlet. For example, Invention Patent Application No. 201720624492.0, titled “US-style Power Strip”, discloses the following structure: a US-style power strip includes a cuboid-shaped power strip body, and a power cord disposed on the power strip body; where two hooks are disposed in parallel on an end face of the power strip body on a side opposite to the power cord, and configured to suspend the US-style power strip; each longitudinal side of the power strip body is provided with a row of three-prong receptacles, and a corresponding protective cover is mounted for each row of three-prong receptacles; where the protective cover is provided with a plurality of protrusions extending into and abuttingly engaging grooves of the three-prong receptacles on the power strip body; and two indicator lights are disposed on the power strip body, each corresponding to one row of the three-prong receptacles to indicate an energization state of each row of the three-prong receptacles.

However, conventional electrical outlets with exposed terminals have the following deficiencies: 1. terminals are susceptible to dust accumulation, which may impair service effects and cause contamination; 2. operators may inadvertently contact the terminals, thereby tending to cause electric shock accidents.

Therefore, it is necessary to arrange a protective configuration for the terminals of such wall-mounted electrical outlets.

### SUMMARY

In view of the deficiencies in the prior art, the technical problem to be solved by the present disclosure is to provide a protective configuration for electrical outlet terminals, which simultaneously achieves both effective protection of the terminals and convenience for wiring operation.

To this end, the present disclosure is implemented by the following technical solution:

A protective configuration for electrical outlet terminals includes a main housing provided with terminals, where the main housing is provided with mounting grooves recessed inward from an outer surface of the main housing, and the terminals are mounted within the mounting grooves; and a flippable protective cover plate is disposed for each of the mounting grooves, an upper portion of the protective cover plate is pivotally connected to the main housing, a mutually engageable force-releasable snap-fit mechanism is disposed for the protective cover plate and the main housing, and the snap-fit mechanism is engaged when the protective cover plate is closed to cover the mounting groove.

Preferably, an end plate groove is surroundingly formed within each of the mounting grooves, a wiring end plate is embedded in the end plate groove, a wiring post is threadedly connected to the wiring end plate, and the wiring end plate is conductively connected to internal components.

Preferably, an upper portion of each of the mounting grooves is provided with pivot holes on both sides, the upper portion of each of the protective cover plates is provided with pivot shafts on both side ends, and the pivot shafts are inserted into the pivot holes.

Preferably, the main housing includes an upper housing, a middle housing, and a lower housing, where the upper housing and the lower housing are sleeved at upper and lower ends of the middle housing respectively, and the pivot holes are formed by joint surrounding of the upper housing and the middle housing on both sides of each of the mounting grooves.

Preferably, each of the protective cover plates includes an inclined portion and a parallel portion, where the inclined portion extends obliquely outward from a connection end at an upper portion and is connected to the parallel portion; the parallel portion is parallel to a side surface of the main housing, and the parallel portion is received within the mounting groove, with an outer surface of the parallel portion flush with an outer surface of the main housing; and an inner wall of each of the mounting grooves is provided with an inner protrusion at a laterally central position, an inner side of the protective cover plate is provided with an outer protrusion corresponding to the inner protrusion, and the outer protrusion abuts against the inner protrusion when the protective cover plate is closed inward.

Preferably, strip-shaped stepped surfaces are disposed on both sides of each of the mounting grooves, and both sides of each of the protective cover plates abut against the strip-shaped stepped surfaces when the protective cover plate is closed; the snap-fit mechanism includes latching tabs and latching grooves, both sides of a middle of the protective cover plate are provided inward with the latching tabs, the strip-shaped stepped surfaces are provided with latching grooves matching the latching tabs, and the latching tabs are inserted into the latching grooves to achieve a snap-fit connection; and lower end portions of the latching tabs are provided with lateral engaging protrusions, lower side walls of the latching grooves are provided with engaging grooves matching the engaging protrusions, and upper portions of both the engaging protrusions and engaging grooves are provided with mutually matching inclined surfaces or arcuate surfaces.

Preferably, each of the mounting grooves extends downwardly to a bottom portion, and a lower end of each of the protective cover plates is provided with a downwardly protruding arcuate end.

Preferably, each side of the main housing is provided with one mounting groove, and one terminal is disposed within each of the mounting grooves.

By employing the above technical solution, the present disclosure has the following beneficial effects:
1. The flippable protective cover plates used in the present disclosure achieve effective coverage of the terminals, and the force-releasable snap-fit mechanisms are configured to maintain the flippable protective cover plates in a covered state, thereby providing dust-proof, contamination-proof, and accidental contact-proof functions. The protective cover plates are easy to open, thus achieving convenience for wiring operation.
2. Each of the protective cover plates includes the inclined portion and the parallel portion, and this configuration obliquely extends outward to expand an inner space of the protective cover plate, thereby facilitating wiring operation and wire placement. Moreover, by means of the inner protrusion, partitioning of wiring paths on both sides is achieved, thus enabling an orderly wire arrangement.
3. The snap-fit mechanism formed by the latching tabs and the latching grooves is employed, and complementary portions between the engaging protrusions of the latching tabs and the engaging grooves of the latching grooves in a disengagement direction are configured with inclined surfaces or arcuate surfaces. Since both the main housing and the protective cover plate of the electrical outlet are made of a slightly elastic material such as plastic, outward prying of the protective cover plate enables disengagement of the snap-fit mechanism, thereby facilitating coverage protection during engagement and wiring during disengagement.

### BRIEF DESCRIPTION OF THE DRAWINGS

The present disclosure has the following figures:

FIG. 1 is a structural view of an electrical outlet provided by the present disclosure, where the electrical outlet has a protective configuration for electrical outlet terminals.

FIG. 2 is a side view of the electrical outlet of FIG. 1 with a protective cover plate removed.

FIG. 3 is a bottom view of FIG. 2.

FIG. 4 is a perspective view of a protective cover plate in FIG. 1.

FIG. 5 is a side view of FIG. 4.

FIG. 6 is a side view of the electrical outlet of FIG. 1.

FIG. 7 is a sectional view taken along line A-A in FIG. 6.

### DETAILED DESCRIPTIONS OF THE EMBODIMENTS

To further elaborate on the technical means employed by the present disclosure to achieve the intended objectives and the resultant efficacy, the specific implementations, structures, features, and functions of the present disclosure will be described below in detail in combination with the drawings and preferred embodiments.

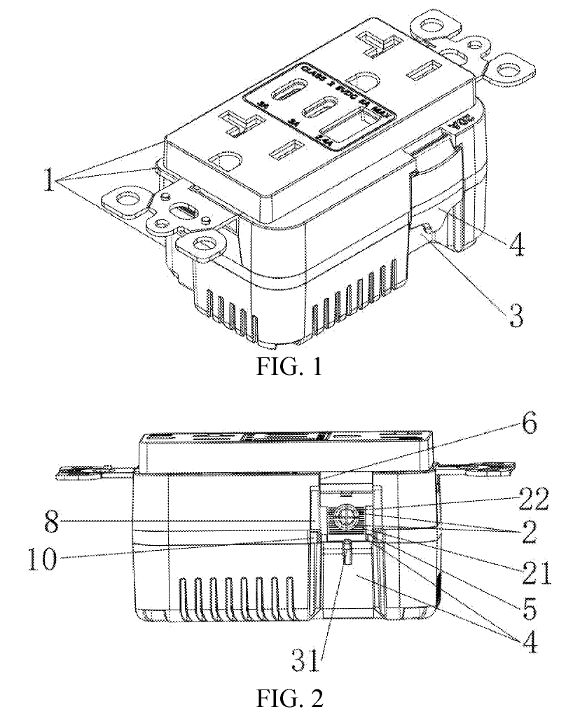

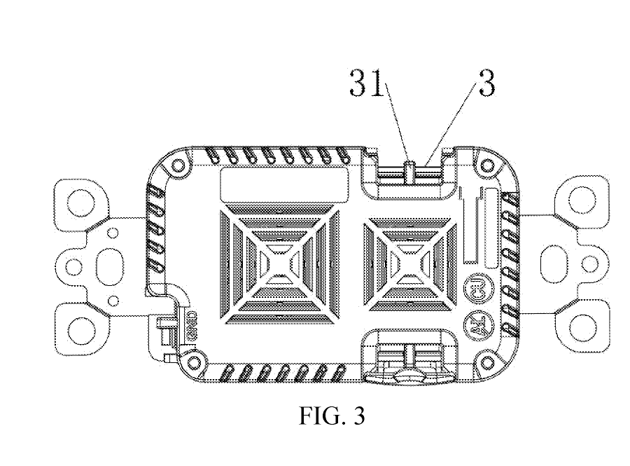

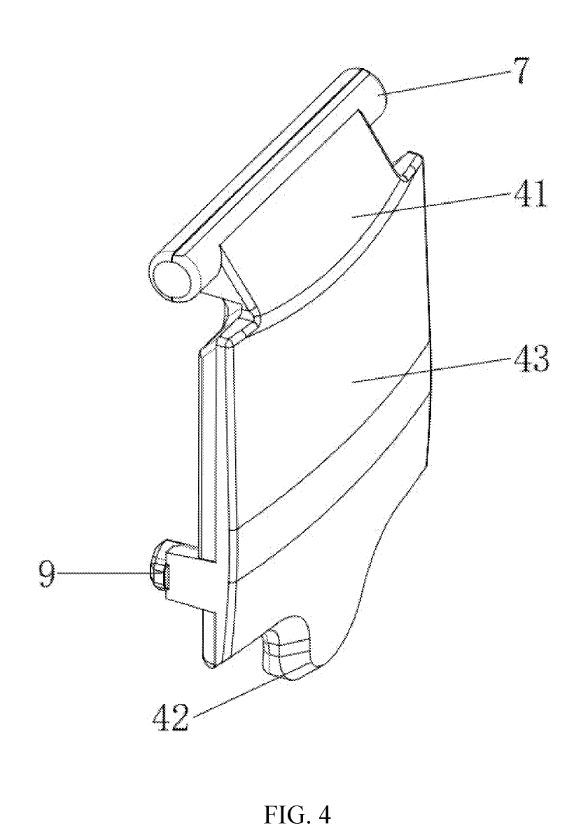

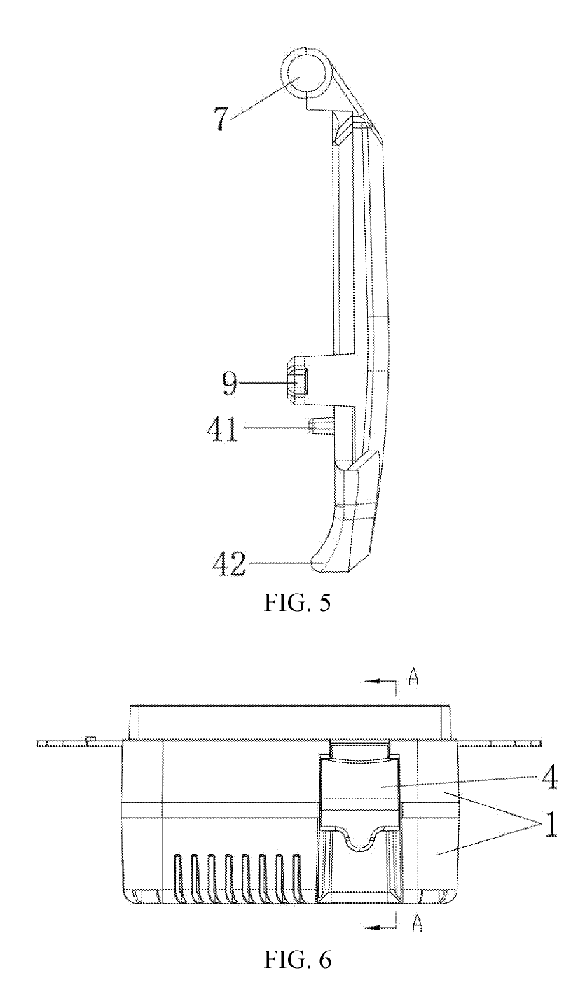

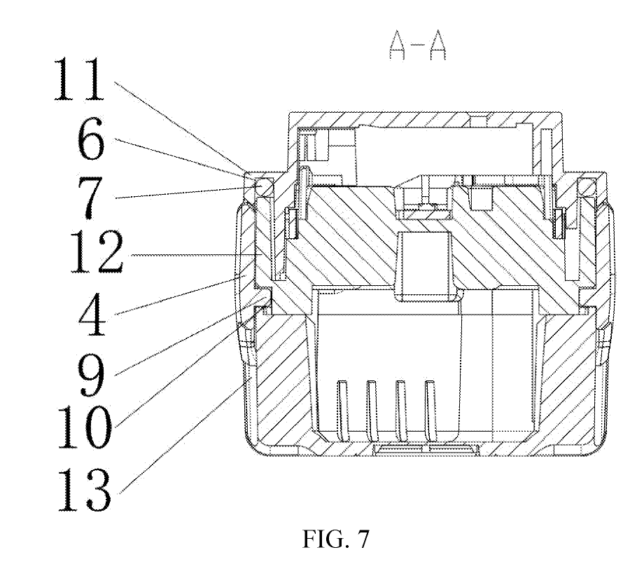

Referring to FIGS. 1-7, a protective configuration for electrical outlet terminals provided by the present disclosure includes a main housing 1 provided with terminals 2, where the main housing 1 is provided with mounting grooves 3 recessed inward from an outer surface of the main housing 1. In this embodiment, each side of the main housing 1 is provided with one mounting groove 3, one terminal 2 is disposed within each of the mounting grooves 3, and the terminals 2 are mounted within the mounting grooves 3;and a flippable protective cover plate 4 is disposed for each of the mounting grooves 3, an upper portion of the protective cover plate 4 is pivotally connected to the main housing 1, a mutually engageable force-releasable snap-fit mechanism is disposed for the protective cover plate 4 and the main housing 1, and the snap-fit mechanism is engaged when the protective cover plate 4 is closed to cover the mounting groove 3. Each of the terminals 2 includes a wiring screw 22 and a wiring end plate 21, where wiring end plate 21 is conductively connected to internal components, typically an extended end of the wiring end plate 21 is directly inserted into the main housing 1 for connection to the components, and the wiring screw 22 is threadedly connected to the wiring end plate 21; and to mount the wiring end plate 21 more securely, an end plate groove 5 is surroundingly formed within each of the mounting grooves 3, and the wiring end plate 21 is embedded in the end plate groove 5.

Referring to FIGS. 1-7, a pivotal connection structure between each of the protective cover plates 4 and the main housing 1 is detailed as follows: an upper portion of each of the mounting grooves 3 is provided with pivot holes 6 on both sides, the upper portion of the protective cover plates 4 is provided with pivot shafts 7 on both side ends, and the pivot shafts 7 are inserted into the pivot holes 6. The main housing 1 includes an upper housing 11, a middle housing 12, and a lower housing 13, where the upper housing 11 and the lower housing 13 are sleeved at upper and lower ends of the middle housing 12 respectively, and the pivot holes 6 are formed by joint surrounding of the upper housing 11 and the middle housing 12 on both sides of each of the mounting grooves 3.

Referring to FIGS. 1, 4, 5 and 7, each of the protective cover plates 4 includes an inclined portion 41 and a parallel portion 43, where the inclined portion 41 extends obliquely outward from a connection end at an upper portion and is connected to the parallel portion 43; the parallel portion 43 is parallel to a side surface of the main housing 1, and the parallel portion 43 is received within the mounting groove 3, with an outer surface of the parallel portion 43 flush with an outer surface of the main housing 1; and an inner wall of each of the mounting grooves 3 is provided with an inner protrusion 31 at a laterally central position, two wire access channels are partitioned by the inner protrusion 31 on both sides to provide a wire-routing function; an inner side of the protective cover plate 4 is provided with an outer protrusion corresponding to the inner protrusion 31, and the outer protrusion abuts against the inner protrusion 31 when the protective cover plate 4 is closed inward; and the mounting groove 3 extends downwardly to a bottom portion, an external wire is inserted from a lower end of the mounting groove 3 for wiring, and a lower end of the protective cover plate 4 is provided with a downwardly protruding arcuate end 42 which facilitates finger flipping operation.

Referring to FIGS. 2, 3, 4, 5 and 7, strip-shaped stepped surfaces 8 are disposed on both sides of each of the mounting grooves 3, and both sides of each of the protective cover plates 4 abut against the strip-shaped stepped surfaces 8 when the protective cover plate 4 is closed; the snap-fit mechanism includes latching tabs 9 and latching grooves 10, the latching tabs 9 are disposed inward on both sides of a middle of the protective cover plate 4; the strip-shaped stepped surfaces 8 are provided with latching grooves 10 matching the latching tabs 9, and the latching tabs 9 are inserted into the latching grooves 10 to achieve a snap-fit connection; and lower end portions of the latching tabs 9 are provided with lateral engaging protrusions, lower side walls of the latching grooves 10 are provided with engaging grooves matching the engaging protrusions, and upper portions of both the engaging protrusions and engaging grooves are provided with mutually matching inclined surfaces or arcuate surfaces, or a close fit may be employed between the latching tabs 9 and the latching grooves 10 to achieve appropriate locking upon insertion.

A method for using the protective configuration for electrical outlet terminals of the present disclosure includes the following steps: The protective cover plate 4 is flipped upward, the wiring screw 22 is loosened, and a wire is inserted between the wiring end plate 21 and a nut of the wiring screw 22; the wiring screw 22 is tightened to lock the wire; then the protective cover plate 4 is flipped downward to cover the mounting groove, the latching tabs 9 are inserted into the latching grooves 10 to achieve latching, and the latching tabs 9 and the latching grooves 10 are engaged; and opening the protective cover plate 4 only requires applying a slight upward force to overcome the latching.

The above descriptions are only the preferred embodiments of the present disclosure, and should not be construed as a limitation to the present disclosure in any form. Although the present disclosure has been disclosed through the preferred embodiments, such disclosure is not intended to limit the present disclosure. Any person skilled in the art may, without departing from the technical solution scope of the present disclosure, make numerous alterations or modifications to the disclosed technical contents to obtain equivalent embodiments of equivalent variations. Any simple change, equivalent variation, or modification, made to the above embodiments according to the technical essence of the present disclosure without departing from the contents of the technical solutions of the present disclosure, should fall within the protection scope of the technical solutions of the present disclosure.

1. A protective configuration for electrical outlet terminals, comprising a main housing provided with terminals, wherein the main housing is provided with mounting grooves recessed inward from an outer surface of the main housing, and the terminals are mounted within the mounting grooves; and a flippable protective cover plate is disposed for each of the mounting grooves, an upper portion of the protective cover plate is pivotally connected to the main housing, a mutually engageable force-releasable snap-fit mechanism is disposed for the protective cover plate and the main housing, and the snap-fit mechanism is engaged when the protective cover plate is closed to cover the mounting groove.

2. The protective configuration for electrical outlet terminals according to claim 1, wherein an end plate groove is surroundingly formed within each of the mounting grooves, a wiring end plate is embedded in the end plate groove, a wiring post is threadedly connected to the wiring end plate, and the wiring end plate is conductively connected to internal components.

3. The protective configuration for electrical outlet terminals according to claim 2, wherein an upper portion of each of the mounting grooves is provided with pivot holes on both sides, the upper portion of each of the protective cover plates is provided with pivot shafts on both side ends, and the pivot shafts are inserted into the pivot holes.

4. The protective configuration for electrical outlet terminals according to claim 3, wherein the main housing comprises an upper housing, a middle housing, and a lower housing, wherein the upper housing and the lower housing are sleeved at upper and lower ends of the middle housing respectively, and the pivot holes are formed by joint surrounding of the upper housing and the middle housing on both sides of each of the mounting grooves.

5. The protective configuration for electrical outlet terminals according to claim 2, wherein each of the protective cover plates comprises an inclined portion and a parallel portion, wherein the inclined portion extends obliquely outward from a connection end at an upper portion and is connected to the parallel portion; the parallel portion is parallel to a side surface of the main housing, and the parallel portion is received within the mounting groove, with an outer surface of the parallel portion flush with an outer surface of the main housing; and an inner wall of each of the mounting grooves is provided with an inner protrusion at a laterally central position, an inner side of the protective cover plate is provided with an outer protrusion corresponding to the inner protrusion, and the outer protrusion abuts against the inner protrusion when the protective cover plate is closed inward.

6. The protective configuration for electrical outlet terminals according to claim 3, wherein each of the protective cover plates comprises an inclined portion and a parallel portion, wherein the inclined portion extends obliquely outward from a connection end at an upper portion and is connected to the parallel portion; the parallel portion is parallel to a side surface of the main housing, and the parallel portion is received within the mounting groove, with an outer surface of the parallel portion flush with an outer surface of the main housing; and an inner wall of each of the mounting grooves is provided with an inner protrusion at a laterally central position, an inner side of the protective cover plate is provided with an outer protrusion corresponding to the inner protrusion, and the outer protrusion abuts against the inner protrusion when the protective cover plate is closed inward.

7. The protective configuration for electrical outlet terminals according to claim 5, wherein strip-shaped stepped surfaces are disposed on both sides of each of the mounting grooves, and both sides of each of the protective cover plates abut against the strip-shaped stepped surfaces when the protective cover plate is closed; the snap-fit mechanism comprises latching tabs and latching grooves, both sides of a middle of the protective cover plate are provided inward with the latching tabs, the strip-shaped stepped surfaces are provided with latching grooves matching the latching tabs, and the latching tabs are inserted into the latching grooves to achieve a snap-fit connection; and lower end portions of the latching tabs are provided with lateral engaging protrusions, lower side walls of the latching grooves are provided with engaging grooves matching the engaging protrusions, and upper portions of both the engaging protrusions and engaging grooves are provided with mutually matching inclined surfaces or arcuate surfaces.

8. The protective configuration for electrical outlet terminals according to claim 2, wherein each of the mounting grooves extends downwardly to a bottom portion, and a lower end of each of the protective cover plates is provided with a downwardly protruding arcuate end.

9. The protective configuration for electrical outlet terminals according to claim 7, wherein each of the mounting grooves extends downwardly to a bottom portion, and a lower end of each of the protective cover plates is provided with a downwardly protruding arcuate end.

10. The protective configuration for electrical outlet terminals according to claim 2, wherein each side of the main housing is provided with one mounting groove, and one terminal is disposed within each of the mounting grooves.
